(19) United States
(12) Patent Application Publication
(10) Pub. No.: US 2026/0172073 A1
(43) Pub. Date: Jun. 18, 2026

(54) A METHOD PERFORMED BY A COVERAGE ENHANCING DEVICE, A METHOD PERFORMED BY A RADIO NETWORK NODE, AND RELATED DEVICES AND NODES

(71) Applicant: Sony Group Corporation, Tokyo (JP)

(72) Inventors: Fredrik RUSEK, Eslöv (SE); Erik BENGTSSON, Eslöv (SE); Kun ZHAO, Malmö (SE); Jose FLORDELIS, Lund (SE); Olof ZANDER, Södra Sandby (SE)

(21) Appl. No.: 19/122,708

(22) PCT Filed: Oct. 30, 2023
(86) PCT No.: PCT/EP2023/080183

§ 371 Date: Apr. 18, 2025

(30) Foreign Application Priority Data
Nov. 4, 2022 (SE) 2251286-7

(51) Int. Cl. H04B 7/04; H04L 5/00; H04W 8/22; H04W 24/10

(52) U.S. Cl. CPC H04B 7/04013; H04L 5/0051; H04W 8/22; H04W 24/10

(57) ABSTRACT

Disclosed is a method performed by a coverage enhancing device, CED. The method comprises transmitting, to a radio network node, a module arrangement message indicative of a plurality of antenna modules comprised in the CED and their relative orientation.

The present disclosure pertains to the field of wireless communications. The present disclosure relates to a method performed by a coverage enhancing device (CED), a method performed by a radio network node, a related CED and a related radio network node.

### BACKGROUND

Coverage enhancing devices (CEDs), such as smart repeaters and reflective intelligent surfaces (RISs), can provide coverage enhancement for devices using 5G and beyond. Coverage enhancing devices can make use of array gain when retransmitting signals, such as reflecting signals from a wireless device to a base station, and/or from a base station to a wireless device. CEDs can be used to improve signal coverage, for example at hard-to-reach locations, or transitions from outdoors to indoors. Certain coverage enhancing devices can be reconfigurable, such as having the ability to choose a phase shift per coverage enhancing unit cell, such as per antenna element. By applying a phase shift, such as changing the phase, a change of direction of an outgoing signal can be applied. The phase shift, such as phase angles, can be configured to obtain desired incoming and/or outgoing angles of a signal. Typically, the CED retransmits the signal received from the transmitter node in order to reach receiver nodes located out of coverage of the transmitter node using the frequency bandwidth of the signal received by the CED from the transmitter node.

The 3^{rd} Generation Partnership Project (3GPP) is currently working on standardizing CEDs. A part of that effort relates to configuration of CEDs. Currently CEDs typically comprise only a single antenna module. While providing the CED with multiple antenna modules can bring advantages, such as an increased capacity of the CED, the multiple antenna modules may also negatively interfere with each other which may reduce the quality of the retransmitted signals.

### SUMMARY

Accordingly, there is a need for devices and methods for configuring CEDs having multiple antenna modules, which may mitigate, alleviate or address the shortcomings existing and may provide a reduced interference between the plurality of antenna modules of the CED.

Disclosed is a method performed by a coverage enhancing device, CED. The method comprises transmitting, to a radio network node, a module arrangement message indicative of a plurality of antenna modules comprised in the CED and their relative orientation.

Further, a coverage enhancing device, CED, comprising memory circuitry, processor circuitry, and a wireless interface is provided. The CED is configured to perform any of the methods disclosed herein.

It is an advantage of the present disclosure that the CED can enable the radio network node to configure the CED to reduce destructive interference between the antenna modules of the CED. The CED can inform the radio network node of the number of antenna modules comprised in the CED and their relative orientation. Based on this information the radio network node can individually configure the multiple antenna modules to reduce destructive interference between the signals received and/or transmitted by the antenna modules. The radio network node may for example configure one or more of the antenna modules with a phase shift so that the signals received and/or transmitted by the antenna modules constructively superimpose. By the CED enabling the radio network node to configure the CED to reduce destructive interference between the antenna modules of the CED new antenna modules can be added to an already deployed CED without having to modify the existing antenna modules or their codebooks. Instead, the radio network node can configure the CED to ensure that a compound reflection from the antenna modules of the CED adds constructively at the target node, such as a target WD or a target radio network node.

Disclosed is a method performed by a radio network node. The method comprises receiving, from a CED, a module arrangement message indicative of a plurality of antenna modules comprised in the CED and their relative orientation.

Further, a radio network node comprising memory circuitry, processor circuitry, and a wireless interface is provided. The radio network node is configured to perform any of the methods disclosed herein.

It is an advantage of the present disclosure that the radio network node is enabled to configure the CED to reduce destructive interference between the antenna modules of the CED. The radio network node can be informed by the CED of the number of antenna modules comprised in the CED and their relative orientation. Based on this information the radio network node can individually configure the multiple antenna modules to reduce destructive interference between the signals received and/or transmitted by the antenna modules. The radio network node may for example configure one or more of the antenna modules with a phase shift so that the signals received and/or transmitted by the antenna modules constructively superimpose. By the CED enabling the radio network node to configure the CED to reduce destructive interference between the antenna modules of the CED new antenna modules can be added to an already deployed CED without having to modify the existing antenna modules or their codebooks. Instead, the radio network node can configure the CED to ensure that a compound reflection from the antenna modules of the CED adds constructively at the target node, such as a target WD or a target radio network node.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example coverage enhancing device, an example radio network node, and an example wireless device according to this disclosure,

FIG. 2 is a diagram illustrating an example coverage enhancing device comprising a plurality of antenna modules and the components of an example antenna module according to this disclosure,

FIG. 3 is a diagram illustrating two example configurations of devices communicating with the coverage enhancing device according to this disclosure

FIG. 4 is a signaling diagram illustrating an example communication between an example coverage enhancing device, an example radio network node, and an example wireless device according to this disclosure,

FIG. 5 is a flow-chart illustrating an example method, performed by a coverage enhancing device according to this disclosure,

FIG. 6 is a flow-chart illustrating an example method, performed by a radio network node according to this disclosure,

FIG. 7 is a block diagram illustrating an example coverage enhancing device according to this disclosure, and

FIG. 8 is a block diagram illustrating an example radio network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

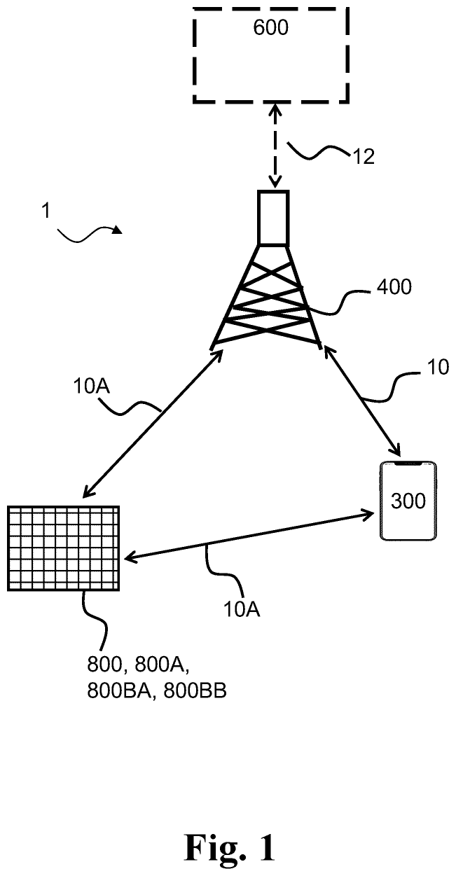

FIG. 1 is a diagram illustrating an example wireless communication system 1 according to this disclosure. The wireless communication system 1 comprises a wireless device 300, a network node 400 and a core network (CN) node 600.

As discussed in detail herein, the present disclosure relates to a wireless communication system 1 comprising a cellular system, for example, a 3GPP wireless communication system.

A network node disclosed herein refers to a radio access network (RAN) node operating in the radio access network, such as a base station, an evolved Node B, eNB, gNB in NR, and/or a transmission and reception point (TRP). In one or more examples, the RAN node is a functional unit which may be distributed in several physical units.

The CN node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more examples, the CN node is a functional unit which may be distributed in several physical units.

The wireless communication system 1 described herein may comprise one or more wireless devices 300, and/or one or more network nodes 400, such as one or more of a base station, an eNB, a gNB and an access point.

A wireless device 300 may refer to a mobile device and/or a user equipment (UE). The wireless device 300 may be configured to communicate with the network node 400 via a wireless link (or radio access link) 10.

The wireless communication system 1 may comprise a coverage enhancing device (CED) 800. The CED 800 may be one or more of a smart repeater, such as a Network Controlled Repeater (NCR), a reflective intelligent surface (RIS), an integrated access and backhaul (IAB), and/or another wireless device (WD), such as a WD communicating via sidelink. The CED 800 may provide coverage enhancement for devices using 5G and beyond. The CED 800 may be configurable by the network node 400 and may be used to improve signal coverage in the wireless communication system 1. The CED 800 may be used to retransmit, such as forward, signals, such as data and/or control signals, between the network node 400 and the WD 300. The retransmission can be advantageous when the WD 300 is located at hard-to-reach locations, such as at a border of a coverage area of the network node 400 and/or when a direct (such as a line-of-sight) link between the network node 400 and the WD 300 is obstructed. The CED 800 may comprise a plurality of antenna elements that can be configured with a respective phase shift. By controlling the phase shifts, such as jointly controlling the phase shifts, an incoming and/or outgoing angle of a signal received and/or transmitted by the CED 800 can be controlled and/or adapted. In one or more example methods, the angle of incoming and outgoing signals can be controlled by controlling the relative phase between antenna elements of the CED 800. The phase shift may be a capacitor-based phase shift and/or a true time delay line, such as a time domain shift, between antenna elements of the CED 800. The WD 300 may be configured to communicate with the network node 400 directly via the wireless link (or radio access link) 10 and/or via the CED 800 via wireless link 10A. The wireless link 10A may herein be referred to as a reflected, such as retransmitted, wireless link. The CED 800 may be controlled by one or more network nodes, such as the network node 400, or one or more wireless devices, such as the WD 300. The one or more network nodes or wireless devices controlling the CED 800 may herein be referred to as coverage enhancing device controlling nodes. In one or more example methods, the coverage enhancing device controlling node can be a CN node, such as the CN node 600 in FIG. 1. In one or more example methods, the coverage enhancing device controlling node can be a node in an external network that can access the CED 800, for example through the internet via a gateway function. The CED 800 may comprise one or more of a controller 800A, a first antenna module 800BA, and a second antenna module 800BB.

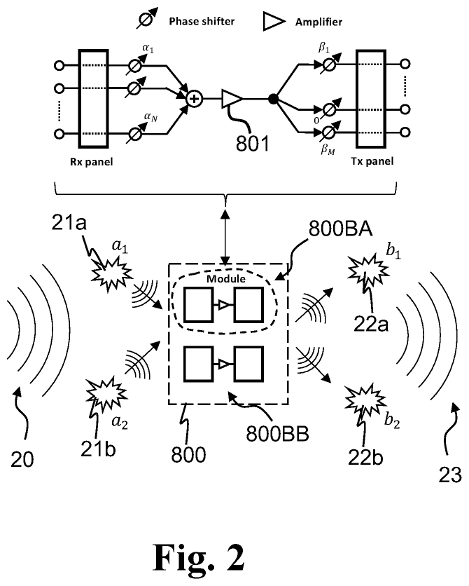

FIG. 2 illustrates a CED comprising two modules, such as two antenna modules. Signals a₁, a₂ from a transmitter (Tx) arrive at the CED through two clusters. Signals b₁, b₂ sent from the CED towards a receiver (Rx) reach the Rx through two clusters. A cluster can herein be seen as a scattering object, or a scatterer, such as an object that can reflect signals from a transmitter and into a receiver. Multipath components propagating through a scatterer tend to be clustered in a delay-angle domain. For example, the multipath components may arrive from similar angles-of-arrival and undergo similar propagation delays. In one or more examples, a LOS component can mathematically also be represented with a cluster. In one or more example antenna modules, the antenna module may comprise a receive array, such as a one phased receive array, a power amplifier, and a transmit array, such as a one phased transmit array. In one or more example CEDs, the CED may comprise a plurality of antenna modules. The dashed circle in FIG. 2 indicates one of a plurality of antenna modules comprised in the CED. Each of the plurality of antenna modules comprises two phased arrays a, b, interconnected by an amplifier, such as one or more amplifiers. A phased array can herein be seen as an array of phase shifters, for adjusting the phase of a number of receive antennas 1-n and/or transmit antennas 1-m of the CED, where the receive antennas can be denoted as a₁₋ₙ, and the transmit antennas can be denoted b₁₋ₘ. In one or more example CED, the phased array a may be a receive array. In one or more example CED, the phased array b may be a transmit array. A transmitter (not shown in FIG. 2) which is located to the left of the CED in FIG. 2 transmits a signal 20 towards the CED (when referring to a CED herein, reference is made to a CED comprising at least two antenna modules, such as at least two antenna modules). The signal 20 may reach the CED through two or more clusters, such as the clusters 21a and 21b. In general, in non line-of-sight scenarios, signals may propagate from a transmitter to a receiver via reflections, refractions and diffractions. The points (or surfaces) at which reflections (or refractions, or diffractions) occur may be referred to as clusters. In the example shown in FIG. 2, the clusters 21a and 21b are two dominant clusters. Upon the antenna modules 800BA, 800BB being located close to each other, such as within a distance in the range of a few centimeters to a few meters, both antenna modules are assumed to see the same clusters with the same strength, such as with the same power, in other words the values aₖ are applicable for both modules. The distance between the antenna modules at which the antenna modules are considered being close to each other may depend on the size of the antenna panels and/or antenna modules. According to the current disclosure, the compounded size of the CED, including all the antenna modules, should be much smaller than a distance between the CED-transmitter and the CED-receiver, as well as a distance from the CED to any significant scattering objects in the environment of the CED. This is reasonable when the two modules are closely located, and with similar spatial orientations. However, the two modules may not see the signal with the same phase. The values aₖ can thus only represent power, not phase. By normalizing

$${a}_{1}^{2} + {a}_{2}^{2} = 1 ,$$

a₁ can be expressed a a₁=a≥0 and a₂ can be expressed as a₂=\sqrt{1−a²}. This model encompasses a pure Line-of-Sight (LOS) scenario where the signal is not obstructed by any objects located between the transmitter and the receiver of the signal, for which a≈1.

Similarly, a signal 23 transmitted from the CED may reach a receiver (not shown in FIG. 2) located to the right of the CED through two clusters. Again, the values bₖ shown in FIG. 2 may represent power, but not phase. Similar to the received signal, the transmitted clusters may be defined as b₁=b≥0 and b₂=\sqrt{1−b²}. A LOS situation towards the receiver may be modeled as b≈1.

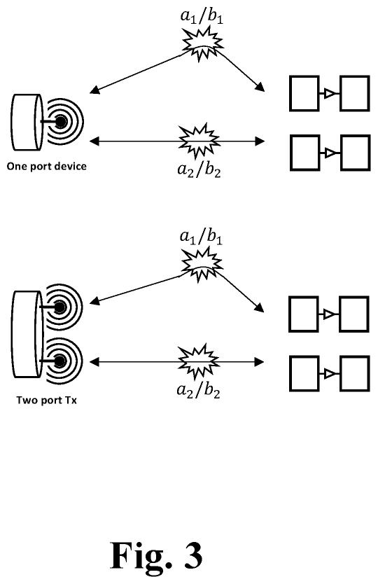

FIG. 3 shows two different types of antenna module configurations for the CED. Depending on the configuration of the antenna modules the signals transmitted from the transmitter and/or receiver discussed in relation to FIG. 2 may differ. For the signal 20 transmitted from the transmitter, the transmitter may either be able to access the two clusters independently, or it may not. In other words, the transmitter may be capable of forming two beams, one beam towards each cluster, and feed the beams with independent data. The alternative is that the transmitter can only form a single beam towards the two clusters, which implies that the two clusters are fed the same data. Similar arguments apply for the signal 23 transmitted from the CED towards a receiver. Either the receiver can observe the two clusters with individual beams, or it cannot. These scenarios are illustrated in FIG. 3, where the wording “one-port” device corresponds to the case where the transmitter and/or the receiver is only able to form or receive one single beam with the same data, and “two-port” device corresponds to the case where the transmitter and/or the receiver can form or receive two beams with independent data. The devices shown in FIG. 3 can be either the receiver or the transmitter.

The capacities of the system shown in FIG. 2 and FIG. 3, such as the maximum data rates supported by the system, including the channel, are illustrated in Table 1. In one or more example methods, the operation modes of the CED may relate to whether or not beam split is used and to how input clusters are connected to output clusters. In Table 1, the rows of the table may correspond to operation modes of the system, such as of the CED. An operational mode may for example indicate whether the Tx-channel and/or the Rx-channel has one or two ports. In addition, for the case when both Tx-channel and the Rx-channel have two-ports, such as in the fourth and last row of Table 1, there are two operation modes, corresponding to Rank-1 or Rank-2 transmissions.

TABLE 1

| | | Rank 1 transmissions | | Rank 2 transmissions | |
|---|---|---|---|---|---|
| Tx-CED | Rx-CED | Beam Split | No Beam Split | Beam Split | No Beam |
| channel | channel | Capacity | Capacity | Capacity | Split Capacity |
| [a \sqrt{1 − a²}] | [b \sqrt{1 − b²}] | ${log}_{2} ( 1 + \frac{8 {N}^{2}}{{N}_{0}} )$ | ${log}_{2} ( 1 + \frac{8 {N}^{2}}{{N}_{0}} {a}_{max} {b}_{max} )$ | N/A | N/A |
| [a \sqrt{1 − a²}] | $[ \begin{matrix}b & 0 \\ 0 & \sqrt{1 - {b}^{2}}\end{matrix} ]$ | ${log}_{2} ( 1 + \frac{8 {N}^{2}}{{N}_{0}} {b}_{max} )$ | ${log}_{2} ( 1 + \frac{8 {N}^{2}}{{N}_{0}} {a}_{max} {b}_{max} )$ | N/A | N/A |
| $[ \begin{matrix}a & 0 \\ 0 & \sqrt{1 - {a}^{2}}\end{matrix} ]$ | [b \sqrt{1 − b²}] | ${log}_{2} ( 1 + \frac{8 {N}^{2}}{{N}_{0}} {a}_{max} )$ | ${log}_{2} ( 1 + \frac{8 {N}^{2}}{{N}_{0}} {a}_{max} {b}_{max} )$ | N A | N/A |
| $[ \begin{matrix}a & 0 \\ 0 & \sqrt{1 - {a}^{2}}\end{matrix} ]$ | $[ \begin{matrix}b & 0 \\ 0 & \sqrt{1 - {b}^{2}}\end{matrix} ]$ | ${log}_{2} ( 1 + \frac{8 {N}^{2}}{{N}_{0}} {a}_{max} {b}_{max} )$ | ${log}_{2} ( 1 + \frac{8 {N}^{2}}{{N}_{0}} {a}_{max} {b}_{max} )$ | max(C_{I}, C_̅{̅I̅}̅) + ϵ | max(C_{I}, C_̅{̅I̅}̅) + |
| | | | | | No corridination |

where

$${a}_{max} = max ( {a}^{2} , 1 - {a}^{2} )$$

$${b}_{max} = max ( {b}^{2} , 1 - {b}^{2} )$$

$${C}_{1} = \begin{matrix}max \\ osps \sqrt{2}\end{matrix} {log}_{2} ( 1 + \frac{{N}^{2}}{{N}_{0}} {p}^{2} {a}^{2} {b}^{2} ) + {log}_{2} ( 1 + \frac{{N}^{2}}{{N}_{0}} ( 2 - {p}^{2} ) 1 - {a}^{2} ) 1 - {b}^{2} ) )$$

$${C}_{1} = \begin{matrix}max \\ osps \sqrt{2}\end{matrix} {log}_{2} ( 1 + \frac{{N}^{2}}{{N}_{0}} {p}^{2} {a}^{2} ( 1 - {b}^{2} ) ) + {log}_{2} ( 1 + \frac{{N}^{2}}{{N}_{0}} ( 2 - {p}^{2} ) 1 - {a}^{2} ) {b}^{2} )$$

$$ϵ indicates a very small number$$

In Table 1 the notations and definitions are the following:
N defines the number of antenna elements at each of the phased arrays in the antenna modules of the CED. In one or more example scenarios, the receive and the transmit arrays of the antenna modules may comprise the same number of antenna elements.
N₀ defines a noise density at the receiver. The noise density may absorb other constants, such as path losses.
In the two leftmost columns of Table 1, a row vector indicates that the device communicating with the CED is a 1-port device, and a matrix indicates that the device is a 2-port device.
“Rank 1” and “Rank 2 transmissions” indicate the number of layers the transmitter transmits.
For rank 2, the capacity given is the sum rate across both layers.
The transmit power at the transmitter has in all cases been normalized to 2.
Equal amplification in both CED antenna modules has been assumed. The amplification value is absorbed by the variable N₀.
“Beam split” indicates that an antenna module can focus on two clusters at the same time. It is assumed that the antenna module can do so without any loss.

In all cases except the bottom right case shown in Table 1, such as the “rank 2 without beam split” case, the relative phases between the two antenna modules must be known and compensated for at the CED. The two antenna modules work in concert, and may thus have to be configured to superimpose constructively. However, for the “rank 2 without beam split” case, the phases of the clusters are irrelevant.

The operation of the two antenna modules may be determined based on the “channel-type” information (such as based on the information in the two leftmost columns in Table 1), and the parameters a, b, N²/N₀. Operation may herein comprise “which module listens to which cluster(s)”, “do the antenna modules serve the same layer for rank 2 transmissions”, etc. Once that is determined, the phases of the clusters fully specify all operations (except for the bottom right case for which no phases are needed).

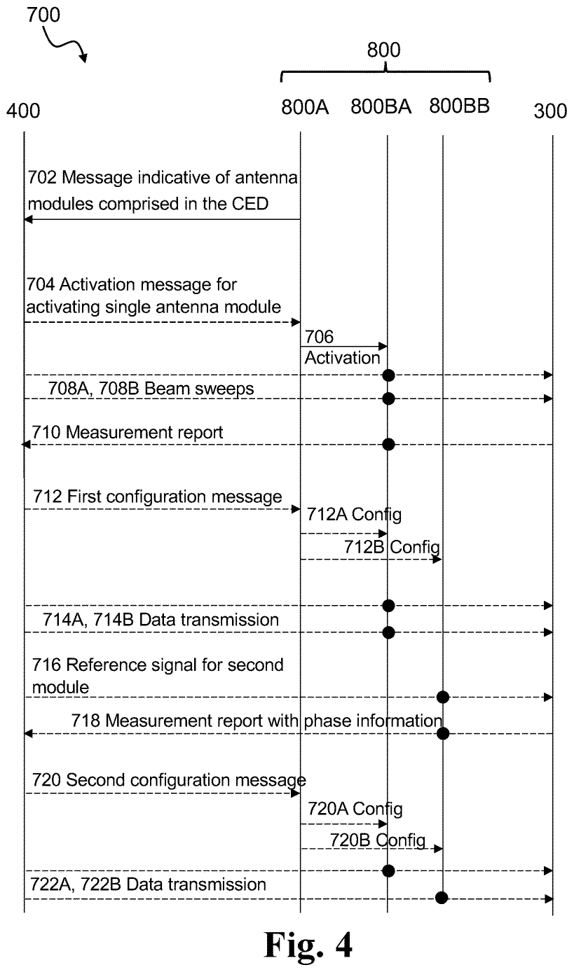

FIG. 4 shows a signaling diagram illustrating an example message exchange between a radio network node 400, a CED 800, and a wireless device 300 according to the current disclosure. The CED 800 may comprise a control unit 800A, such as processor circuitry, a first antenna module 800BA, and a second antenna module 800BB.

The CED 800, such as the control unit 800A of the CED 800, may transmit, to the radio network node 400, a module arrangement message 702 indicative of a plurality of antenna modules comprised in the CED and their relative orientation. The relative orientation of the antenna modules can herein be seen as the orientation of the antenna elements in relation to each other and/or in relation to a base plane, such as to a base plane of the CED. In one or more example methods, the CED 800 may indicate that the CED 800 comprises multiple antenna modules having the same orientation. In one or more example methods, the module arrangement message 702 may indicate that the multiple antenna modules are non-phase coherent.

In response to receiving the module arrangement message 702 indicative of a plurality of antenna modules comprised in the CED and their relative orientation, the radio network node 400 may send an activation message 704 to the CED, configuring the CED 800 to activate one of the available antenna modules in the CED, and/or deactivate the other antenna modules of the CED 800. Upon learning that the CED 800 consists of several antenna modules having non-aligned phases, configures the CED to activate only one of the panels and then sends reference signals.

Upon receiving the activation message 704, the CED 800, such as the control unit 800A of the CED 800, can activate 706, such as turn on, one of the antenna modules. In this example, the CED 800 activates the first antenna module 800BA. The second antenna module 800BB may remain deactivated.

The radio network node 400 performs a beam sweep 708A, 708B, such as by transmitting reference signals over a plurality of beams towards the CED 800. The CED 800 may relay the beam sweep using the active antenna module, such as the first antenna module 800BA, to the wireless device 300.

The wireless device 300 may measure on the beam sweep, such as on the reference signals of the beam sweep. The measurement may for example be a Reference Signal Receive Power (RSRP) measurement.

The wireless device 300 sends a first measurement report 710, such as an enhanced RSRP measurement report or a channel state information report, to the radio network node 400 via the CED 800, such as via the active antenna module 800BA. The measurement report 710 may comprise first phase information related to the first antenna module 800BA.

Based on the measurement report, the radio network node 400 determines an operation mode of the CED 800, such as whether the transmitter and/or receiver of the CED is a one-port device or a two-port device, whether the CED operates with rank 1 or rank 2, and/or whether the CED has beam-split capacity or not.

In one or more example methods, such as when the radio network node determines that the CED has rank 2 capability but no beam-split capacity, the radio network node may send a first configuration message 712 configuring both antenna modules 800BA and 800BB based on the measurement report received from the WD 300 based on signal relayed by the CED 800 using the single antenna module 800BA.

The CED 800, such as the control unit 800A of the CED 800 configures 712A, 712B both antenna modules 800BA, 800BB based on the first configuration message 712.

Once the antenna modules 800BA, 800BB have been configured, the radio network node may transmit data 714A, 714B to the wireless device 300 via the CED 800 using both antenna modules 800BA, 800BB, without the antenna modules 800BA, 800BB negatively interfering with each other.

In one or more example methods, such as when the radio network node determines that the CED has any other operation mode than rank 2 capability with no beam-split capacity, the radio network node transmits reference signals 716 to the second antenna module 800BB of the CED 800. Prior to transmitting the reference signal 716, the radio network node may configure the CED 800 to activate the second antenna module 800BB. The reference signals 716 may be relayed by the CED 800 using the second antenna module 800BB to the WD 300. In one or more example methods, the first antenna module 800BA may be deactivated when the second antenna module 800BB is activated. In one or more example methods, the first antenna module 800BA may remain activated when the second antenna module 800BB is activated.

The WD 300 may measure on the reference signals and may transmit a second measurement report 718 to the radio network node 400, such as via the CED 800. The measurement report may comprise second phase information related to the second antenna module 800BB. The phase information may be indicative of a phase difference between the second antenna module 800BB and the first antenna module 800BA. In one or more example methods, the second measurement report may comprise RSRP measurements for the second antenna module.

Based on the second measurement report and/or the phase information, the radio network node may send a second configuration message 720 to the CED. The configuration message 720 may comprise configurations for one or more of the antenna modules, such as for both of the antenna modules 800BA, 800BB of the CED 800. The second configuration message 720 may comprise a phase shift to be applied to one or more of the antenna modules for aligning the phases of the antenna modules 800BA, 800BB.

The CED 800, such as the control unit 800A, configures 720A, 720B the first antenna module 800BA and the second antenna module 800BB, based on the second configuration message 720 and/or the phase shift comprised in the second configuration message 720. Configuring 720A, 720B may comprise adjusting the phase shifters comprised in the antenna modules 800BA, 800BB to compensate for the phase difference between the antenna modules.

Once the antenna modules 800BA, 800BB have been configured, the radio network node may transmit data 722A, 722B to the wireless device 300 via the CED 800 using both antenna modules 800BA, 800BB, without the antenna modules 800BA, 800BB negatively interfering with each other.

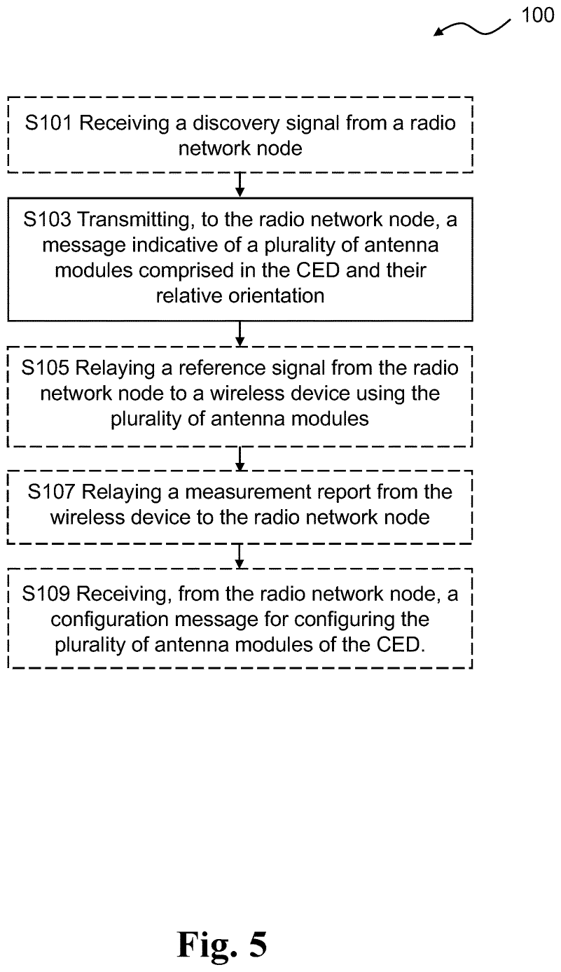

FIG. 5 shows a flow-chart of an example method 100, performed by a coverage enhancing device, CED, according to the disclosure. The CED is the CED disclosed herein, such as CED 800 of FIGS. 1-3 and FIG. 7. The method may be a method for configuring the CED, such as a method for configuring a phase shift of the CED.

In one or more example methods, the method 100 comprises receiving S101 a reference signal, such as a discovery signal, such as a Synchronization Signal Block (SSB), from the radio network node. The reference signal, such as the discovery signal, may be received prior to transmitting module arrangement message. In one or more example methods, the method may take place once, such as immediately after installation of the CED. In order to begin the process of configuring the CED, the CED may receive the reference signal, such as the discovery signal. The discovery signal may in one or more example methods, be an implicit request from the radio network node to the CED to signal its capabilities.

The method 100 comprises transmitting S103, to a radio network node, a module arrangement message indicative of a plurality of antenna modules comprised in the CED and their relative orientation. The plurality of antenna modules may be separate antenna modules associated with a respective Radio Frequency (RF) chain. The module arrangement message, such as the information indicative of the plurality of antenna modules comprised in the CED and their relative orientation, can be used by the radio network node to determine an operation mode of the antenna modules of the CED.

In one or more example methods, the module arrangement message is indicative of at least two of the plurality of antenna modules being non-phase coherent. The antenna modules being non-phase coherent can herein be seen as indicating that the signals reaching the antenna modules and/or originating from the antenna modules having the same power but different phases. In other words, the signals may have no phase relationship. When the phases of the signals at the antenna modules are different, the antenna modules, such as the signals at the modules, may act destructively. In one or more example methods, the module arrangement message may comprise an indication indicating the phase offset of the at least two of the plurality of antenna modules, such as how large the phase offset is between the antenna modules.

In one or more example methods, the module arrangement message is indicative of the antenna modules, such as the at least two of the plurality of antenna modules, having a same receive power in each given spatial direction. The signals having the same receive power can herein be seen as the total incoming power to the at least two of the plurality of antenna modules not having to be the same, but the power in a given spatial direction being the same at the plurality of antenna modules. In one or more example methods, the message may comprise an indication, such as a list, of directions in which the receive power is the same between the at least two of the plurality of antenna modules. In one or more example methods, the message may comprise an indication indicating that the receive power is the same in all directions for the at least two of the plurality of antenna modules. In one or more example methods, the message may comprise an identifier for identifying the at least two of the plurality of antenna modules.

In one or more example methods, the module arrangement message comprises an indication indicative of a number of antenna modules comprised in the CED. The number of antenna modules may, in one or more example methods, be a total number of antenna modules comprised in the CED.

In one or more example methods, the module arrangement message is indicative of one or more of the plurality of antenna modules being offset and co-oriented. Co-oriented can herein be seen as the antenna modules having equal spatial orientation. In one or more example methods, the antenna modules being co-oriented can be seen as the respective antenna arrays of the plurality of antenna modules being located in the same geometric plane. In one or more example methods, the antenna modules being co-oriented can be seen as the respective antenna arrays of the plurality of antenna modules pointing in the same direction. The module arrangement message may comprise information indicative of the antenna modules being likely to observe the clusters with equals strength, such as equal signal strength, but with different phases. In one or more example methods, the module arrangement message indicates that beams of any two antenna modules of the CED are pairwise Type-D Quasi Co-Located (QCL), as defined in 3GPP TS 38.214, v. 17.3.0, Section 5.1.5. Type-D QCL relates to a co-location of a spatial Rx parameter.

In one or more example methods, one of the antenna modules may be a master (such as having a mobile terminal (MT) and communicating with the radio network node. In one or more example methods, the MT may have a separate array, directed towards the radio network node and being co-oriented with all antenna arrays towards the radio network node. All other antenna modules, which can herein be referred to as slave modules, may have access arrays, such as antenna arrays, which may be co-oriented. In other words, the antenna used by the CED to communicate with the radio network node may be QCL′ed with the access arrays facing the radio network node.

In one or more example methods, the module arrangement message is comprised in a CED capability reporting message. The CED capability message may be a message used by the CED to report its capabilities to the radio network node. In one or more example methods, the capability report may indicate that the CED supports beam-split.

In one or more example methods, the module arrangement message is indicative of one or more of the plurality of antenna modules being offset and non-co-oriented. In one or more example methods, the message may comprise an indication indicating whether the plurality of antenna modules being offset and non-co-oriented are transmitting antenna modules or receiving antenna modules or both.

In one or more example methods, the method 100 comprises relaying S105 a reference signal from the radio network node to a wireless device using the plurality of antenna modules. In one or more example methods, the reference signal may be a Synchronization Signal Block (SSB) or a Channel State Information Reference Signal (CSI-RS). In one or more example methods, relaying S105 of the reference signal may be performed using a single active antenna module. By relaying the reference signal using a single active antenna module, the radio network node may be provided with estimates of the parameters a, b, and N described in relation to FIGS. 2, and 3, and Table 1, from which the radio network node can determine the operations of the antenna module of the CED. By only using a single active antenna module, the reference signal overhead can be reduced compared to using a plurality of antenna modules. By reducing the reference signal overhead, a destructive interference between the antenna modules can be reduced.

In one or more example methods, the method 100 comprises relaying S107 a measurement report from the wireless device to the radio network node. The measurement report may comprise information indicative of one or more of a Reference Signal Receive Power (RSRP), and/or phase information of a signal received by the wireless device. The measurement report may be based on measurements performed on a signal received by the wireless device, such as based on a reference signal received from the CED and/or from the radio network node. The measurement report may in one or more example methods, be based on measurements performed on a signal transmitted by the CED and/or the radio network node using a beam sweep.

In one or more example methods, the method 100 comprises receiving S109, from the radio network node, a configuration message for configuring the plurality of antenna modules of the CED.

In one or more example methods, the configuration message comprises a phase indication indicative of a phase shift, such as a phase compensation, to be applied to one of the plurality of antenna modules. The phase shift may be a phase compensation to be applied to the antenna modules of the CED, such as to the two or more antenna modules of the plurality of antenna modules, to compensate for the non-phase coherence, such as for the phase offset, of the antenna modules of the CED.

In one or more example methods, the configuration message may comprise one or more parameters, such as coefficients, to be applied to the elements of the antenna modules of the CED, such as to the phase shifters and/or the amplifiers. The one or more parameters may be indicative of the phase shift to be applied. In one or more example methods, the coefficients are explicitly indicated. In one or more example methods the coefficients may be implicitly indicated, such that the CED itself can determine the coefficients. In one or more example methods, the configuration message may comprise an indication of the beams to be used by the CED for transmitting and/or receiving a signal. In one or more example methods, the configuration message may comprise an indication of a phase compensation to be applied to the antenna modules, such as to the beams.

In one or more example methods, the configuration message may comprise a beam-split configuration to be applied by the CED. The configuration of beam-split may for example be transmitted when beam-split is supported by the CED.

In one or more example methods, the configuration message comprises a module identifier indicative of the antenna module out of the plurality of antenna modules to which the phase shift is to be applied.

In one or more example methods, the configuration message is received in response to relaying the measurement report. The relayed measurement report may be received by the radio network node which upon receiving the measurement report may configure the CED based on the measurement report and may transmit the configuration message to the CED.

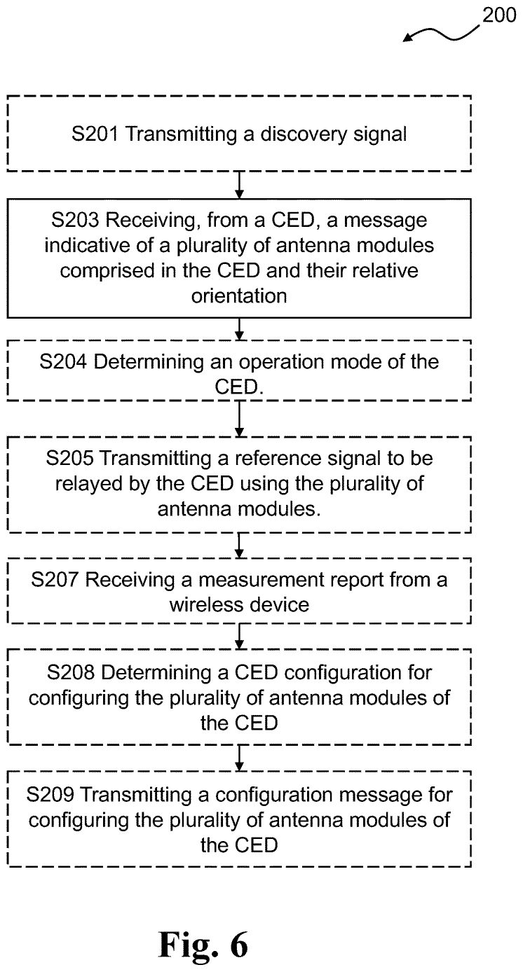

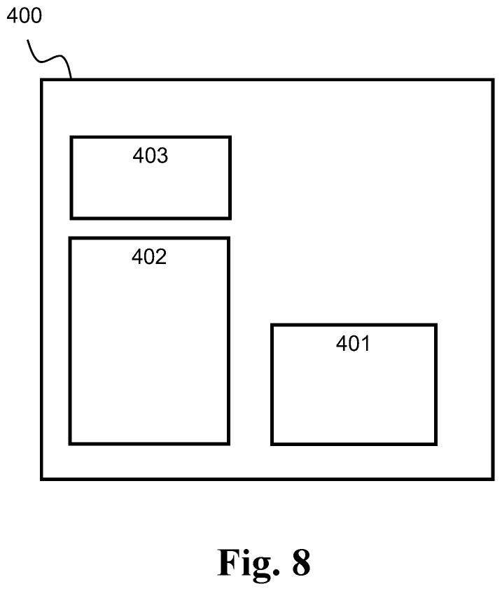

FIG. 6 shows a flow-chart of an example method 200, performed by a radio network node, according to the disclosure. The radio network node is the radio network node disclosed herein, such as radio network node 400 of FIG. 1, FIG. 4, and FIG. 8. The method may be a method for configuring a CED, such as a method for configuring a phase shift of the CED.

In one or more example methods, the method 200 comprises, prior to receiving the module arrangement message, transmitting S201 a reference signal, such as a discovery signal, such as an SSB. The reference signal, such as the discovery signal, may be transmitted prior to receiving the module arrangement message. In one or more example methods, the method may take place once, such as immediately after installation of the CED. In order to begin the process of configuring the CED, the CED may receive the reference signal, such as the discovery signal. The discovery signal may in one or more example methods, be an implicit request from the radio network node to the CED to signal its capabilities.

The method 200 comprises receiving S203, from the CED, the module arrangement message. The plurality of antenna modules may be separate antenna modules associated with a respective Radio Frequency (RF) chain.

In one or more example methods, the radio network node may determine an operation mode of the antenna modules of the CED, based on the module arrangement message. The method 200 may thus comprise, determining S204 an operation mode of the antenna modules of the CED, based on the module arrangement message.

In one or more example methods, the module arrangement message is indicative of the antenna modules being non-phase coherent. The antenna modules being non-phase coherent can herein be seen as the signals reaching the antenna modules and/or originating from the antenna modules having the same power but different phases. In other words, the signals may have no phase relationship. When the phases of the signals at the antenna modules are different the antenna modules, such as the signals at the modules may act destructively. In one or more example methods, the module arrangement message may comprise an indication indicating the phase offset of the at least two of the plurality of antenna modules, such as how large the phase offset is between the antenna modules.

In one or more example methods, the module arrangement message is indicative of the antenna modules, such as the at least two of the plurality of antenna modules, having a same receive power in each given spatial direction. The signals having the same receive power can herein be seen as the total incoming power to the at least two of the plurality of antenna modules not having to be the same, but the power in a given spatial direction being the same at the plurality of antenna modules. In one or more example methods, the message may comprise an indication, such as a list, of directions in which the receive power is the same between the at least two of the plurality of antenna modules. In one or more example methods, the message may comprise an indication indicating that the receive power is the same in all directions for the at least two of the plurality of antenna modules. In one or more example methods, the message may comprise an identifier for identifying the at least two of the plurality of antenna modules.

In one or more example methods, the module arrangement message comprises an indication indicative of a number of antenna modules comprised in the CED. The number of antenna modules may, in one or more example methods, be a total number of antenna modules comprised in the CED.

In one or more example methods, the module arrangement message is indicative of one or more of the plurality of antenna modules being co-oriented and offset. Co-oriented can herein be seen as the antenna modules having equal spatial orientation. The module arrangement message may comprise information indicative of the antenna modules being likely to observe the clusters with equals strength, such as equal signal strength, but with different phases. In one or more example methods, the module arrangement message indicates that beams of any two antenna modules of the CED are pairwise Type-D Quasi Co-Located (QCL), as defined in 3GPP TS 38.214, v. 17.3.0, Section 5.1.5. Type-D QCL relates to a co-location of a spatial Rx parameter.

In one or more example methods, the module arrangement message is indicative of one or more of the plurality of antenna modules being non-co-oriented and offset. In one or more example methods, the message may comprise an indication indicating whether the plurality of antenna modules being offset and non-co-oriented are transmitting antenna modules or receiving antenna modules or both.

In one or more example methods, the module arrangement message is comprised in a CED capability reporting message. The CED capability message may be a message used by the CED to report its capabilities to the radio network node. In one or more example methods, the capability report may indicate that the CED supports beam-split.

In one or more example methods, the method 200 comprises transmitting S205 a reference signal to be relayed by the CED using the plurality of antenna modules. In one or more example methods, the reference signal may be an SSB or a CSI-RS. The reference signal may be transmitted by performing a beam sweep.

In one or more example methods, transmitting S205 the reference signal may be comprise configuring S205A the CED to use a single active antenna module for listening for and/or receiving the reference signal. By configuring the CED to use a single active antenna module for listening for and/or receiving the reference signal, the radio network node may be provided with estimates of the parameters a, b, and N described in relation to FIGS. 2, and 3, and Table 1 for the single antenna module, from which the radio network node can determine the operations of the single antenna module of the CED. By only using a single active antenna module, the reference signal overhead can be reduced compared to using a plurality of antenna modules. By reducing the reference signal overhead, a destructive interference between the antenna modules can be reduced, which gives a better estimation of the parameters a, b, and N of the antenna module.

In one or more example methods, the method 200 comprises receiving S207 a measurement report from a wireless device. The measurement report may comprise information indicative of one or more of a RSRP, and/or phase information of a signal received by the wireless device. The measurement report may be based on measurements performed on a signal received by the wireless device, such as based on a reference signal received from the CED and/or from the radio network node. The measurement report may in one or more example methods, be based on measurements performed on a signal transmitted by the CED and/or the radio network node using a beam sweep.

In one or more example methods, the method comprises determining S208 a CED configuration for configuring the plurality of antenna modules of the CED.

In one or more example methods, the method 200 comprises transmitting S209 a configuration message for configuring the plurality of antenna modules of the CED.

In one or more example methods, the configuration message comprises a phase indication indicative of a phase shift, such as a phase compensation, to be applied to one of the plurality of antenna modules. The phase shift may be a phase compensation to be applied to the antenna modules of the CED, such as to the two or more antenna modules of the plurality of antenna modules, to compensate for the non-phase coherence, such as for the phase offset, of the antenna modules of the CED.

In one or more example methods, the configuration message may comprise one or more parameters, such as coefficients, to be applied to the elements of the antenna modules of the CED, such as to the phase shifters and/or the amplifiers. The one or more parameters may be indicative of the phase shift to be applied. In one or more example methods, the coefficients are explicitly indicated. In one or more example methods the coefficients may be implicitly indicated, such that the CED itself can determine the coefficients. In one or more example methods, the configuration message may comprise an indication of the beams to be used by the CED for transmitting and/or receiving a signal. In one or more example methods, the configuration message may comprise an indication of a phase compensation to be applied to the antenna modules, such as to the beams.

In one or more example methods, the configuration message may comprise a beam-split configuration to be applied by the CED. The configuration of beam-split may for example be transmitted when beam-split is supported by the CED. In one or more example methods, the radio network node may configure beam split for CEDs operating according to the first three rows of Table 1. In one or more example methods, the radio network node may not configure beam split for CEDs performing Rank 2 transmission.

In one or more example methods, the configuration message comprises a module identifier indicative of the antenna module out of the plurality of antenna modules to which the phase shift is to be applied.

In one or more example methods, the configuration message is transmitted in response to receiving the measurement report.

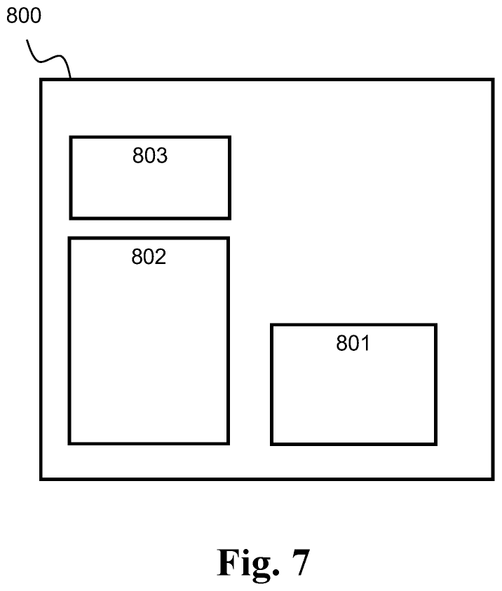

FIG. 7 shows a block diagram of an example CED 800 according to the disclosure. The CED 800 comprises memory circuitry 801, processor circuitry 802, and a wireless interface 803. The CED 800 may be configured to perform any of the methods disclosed in FIG. 5. In other words, in one or more example CEDs, the CED 800 may be configured for configuring the CED, such as for configuring a phase shift of the CED.

The CED 800 is configured to communicate with a radio network node, such as the radio network node disclosed herein, and/or a wireless device, using a wireless communication system.

The wireless interface 803 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The CED 800 is configured to transmit (such as, using the processor circuitry 802 and/or the wireless interface 803), to the radio network node, a module arrangement message.

Processor circuitry 802 is optionally configured to perform any of the operations disclosed in FIG. 5 (such as any one or more of S101, S103, S105, S107, S109). The operations of the CED 800 may be embodied in the form of executable logic routines (for example, lines of code, software programs, etc.) that are stored on a non-transitory computer readable medium (for example, memory circuitry 801) and are executed by processor circuitry 802.

Furthermore, the operations of the CED 800 may be considered a method that the CED 800 is configured to carry out. Also, while the described functions and operations may be implemented in software, such functionality may also be carried out via dedicated hardware or firmware, or some combination of hardware, firmware and/or software.

Memory circuitry 801 may be one or more of: a buffer, a flash memory, a hard drive, a removable media, a volatile memory, a non-volatile memory, a random access memory (RAM), and any other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 7). Memory circuitry 801 is considered a non-transitory computer readable medium.

Memory circuitry 801 may be configured to store information, such as information indicative of the plurality of antenna modules comprised in the CED and their relative orientation, information indicative of a phase shift to be applied, and or parameters to be applied to the CED, in a part of the memory.

FIG. 8 shows a block diagram of an example radio network node 400 according to the disclosure. The radio network node 400 comprises memory circuitry 401, processor circuitry 402, and a wireless interface 403. The radio network node 400 may be configured to perform any of the methods disclosed in FIG. 6. In other words, the radio network node 400 may be configured for configuring the CED, such as for configuring a phase shift of the CED.

The radio network node 400 is configured to communicate with a CED, such as the CED disclosed herein, and/or with a wireless device, using a wireless communication system.

The wireless interface 403 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The radio network node 400 is configured to receive (such as, using the processor circuitry 402 and/or the wireless interface 403), from the CED, a module arrangement message.

Processor circuitry 402 is optionally configured to perform any of the operations disclosed in FIG. 6 (such as any one or more of S201, S203, S205, S207, S209). The operations of the radio network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the radio network node 400 may be considered a method that the radio network node 400 is configured to carry out. Also, while the described functions and operations may be implemented in software, such functionality may also be carried out via dedicated hardware or firmware, or some combination of hardware, firmware and/or software.

Memory circuitry 401 may be one or more of: a buffer, a flash memory, a hard drive, a removable media, a volatile memory, a non-volatile memory, a random access memory (RAM), and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 8). Memory circuitry 401 is considered a non-transitory computer readable medium.

Memory circuitry 401 may be configured to store information, such as information indicative of the plurality of antenna modules comprised in the CED and their relative orientation, information indicative of a phase shift to be applied, and or parameters to be applied to the CED, in a part of the memory.

Examples of methods and products (CED and radio network node) according to the disclosure are set out in the following items:
Item 1. A method performed by a Coverage Enhancing Device, CED, the method comprising:
   transmitting (S103), to a radio network node, a module arrangement message indicative of a plurality of antenna modules comprised in the CED and their relative orientation.
Item 2. The method according to Item 1, wherein the module arrangement message is indicative of at least two of the plurality of antenna modules being non-phase coherent.
Item 3. The method according to Item 1 or 2, wherein the module arrangement message is indicative of the antenna modules having a same receive power in each given spatial direction.
Item 4. The method according to any one of the previous Items, wherein the module arrangement message is comprised in a CED capability reporting message.
Item 5. The method according to any one of the previous Items, wherein the module arrangement message comprises an indication indicative of a number of antenna modules comprised in the CED.
Item 6. The method according to any one of the previous Items, wherein the module arrangement message is indicative of one or more of the plurality of antenna modules being offset and co-oriented.
Item 7. The method according to any one of the previous Items, wherein the module arrangement message is indicative of one or more of the plurality of antenna modules being offset and non-co-oriented.
Item 8. The method according to any one of the previous Items, wherein the method comprises:
   receiving (S109), from the radio network node, a configuration message for configuring the plurality of antenna modules of the CED.
Item 9. The method according to Item 8, wherein the configuration message comprises a phase indication indicative of a phase shift to be applied to one of the plurality of antenna modules.
Item 10. The method according to Item 9, wherein the configuration message comprises a module identifier indicative of the antenna module out of the plurality of antenna modules to which the phase shift is to be applied.
Item 11. The method according to any one of the previous Items, wherein the method comprises relaying (S105) a reference signal from the radio network node to a wireless device using the plurality of antenna modules.
Item 12. The method according to Item 11, wherein the method comprises relaying (S107) a measurement report from the wireless device to the radio network node.
Item 13. The method according to Item 8 and 12, wherein the configuration message is received in response to relaying the measurement report.
Item 14. The method according to any one of the previous Items, wherein the method comprises:
   prior to transmitting the module arrangement message, receiving (S101) a discovery signal from the radio network node.
Item 15. A method performed by a radio network node, the method comprising:
   receiving (S103), from a CED, a module arrangement message indicative of a plurality of antenna modules comprised in the CED and their relative orientation.
Item 16. The method according to Item 15, wherein the module arrangement message is indicative of the antenna modules being non-phase coherent.
Item 17. The method according to Item 15 or 16, wherein the module arrangement message is indicative of the antenna modules having a same receive power in each given spatial direction.
Item 18. The method according to any one of the Items 15 to 17, wherein the module arrangement message is comprised in a CED capability reporting message.
Item 19. The method according to any one of the Items 15 to 18, wherein the module arrangement message comprises an indication indicative of a number of antenna modules comprised in the CED.
Item 20. The method according to any one of the Items 15 to 19, wherein the module arrangement message is indicative of one or more of the plurality of antenna modules being co-oriented and offset.
Item 21. The method according to any one of the Items 15 to 20, wherein the module arrangement message is indicative of one or more of the plurality of antenna modules being non-co-oriented and offset.
Item 22. The method according to any one of the previous Items, wherein the method comprises:
   transmitting (S209) a configuration message for configuring the plurality of antenna modules of the CED.
Item 23. The method according to Item 22, wherein the configuration message comprises a phase indication indicative of a phase shift to be applied to one of the plurality of antenna modules.
Item 24. The method according to Item 23, wherein the configuration message comprises a module identifier indicative of the antenna module out of the plurality of antenna modules to which the phase shift is to be applied.
Item 25. The method according to any one of the previous Items, wherein the method comprises transmitting (S205) a reference signal to be relayed by the CED using the plurality of antenna modules.
Item 26. The method according to Item 25, wherein the method comprises receiving (S207) a measurement report from a wireless device.
Item 27. The method according to Item 22 and 26, wherein the configuration message is transmitted in response to receiving the measurement report.
Item 28. The method according to any one of the Items 15 to 27, wherein the method comprises:
   prior to receiving the module arrangement message, transmitting (S201) a discovery signal.
Item 29. A Coverage Enhancing Device, CED, comprising memory circuitry, processor circuitry, and a wireless interface, wherein the CED is configured to perform any of the methods according to any of Items 1-14.
Item 30. A radio network node comprising memory circuitry, processor circuitry, and a wireless interface, wherein the radio network node is configured to perform any of the methods according to any of Items 15-28.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a Coverage Enhancing Device (CED), the method comprising:
transmitting, to a radio network node, a module arrangement message indicative of a plurality of antenna modules comprised in the CED and their relative orientation.

2. The method according to claim 1, wherein the module arrangement message is indicative of at least two of the plurality of antenna modules being non-phase coherent.

3. The method according to claim 1, wherein the module arrangement message is indicative of the antenna modules having a same receive power in each given spatial direction.

4. The method according to claim 1, wherein the module arrangement message is comprised in a CED capability reporting message.

5. The method according to claim 1, wherein the module arrangement message comprises an indication indicative of a number of antenna modules comprised in the CED.

6. The method according to claim 1, wherein the module arrangement message is indicative of one or more of the plurality of antenna modules being offset and co-oriented.

7. The method according to claim 1, wherein the module arrangement message is indicative of one or more of the plurality of antenna modules being offset and non-co-oriented.

8. The method according to claim 1, wherein the method comprises:
receiving, from the radio network node, a configuration message for configuring the plurality of antenna modules of the CED.

9. The method according to claim 8, wherein the configuration message comprises a phase indication indicative of a phase shift to be applied to one of the plurality of antenna modules.

10. The method according to claim 9, wherein the configuration message comprises a module identifier indicative of the antenna module out of the plurality of antenna modules to which the phase shift is to be applied.

11. The method according to claim 1, wherein the method comprises relaying a reference signal from the radio network node to a wireless device using the plurality of antenna modules.

12. The method according to claim 11, wherein the method comprises relaying a measurement report from the wireless device to the radio network node.

13. The method according to claim 8, wherein the configuration message is received in response to relaying the measurement report.

14. The method according to claim 1, wherein the method comprises:
prior to transmitting the module arrangement message, receiving a discovery signal from the radio network node.

15. A method performed by a radio network node, the method comprising:
receiving, from a CED, a module arrangement message indicative of a plurality of antenna modules comprised in the CED and their relative orientation.

16. The method according to claim 15, wherein the module arrangement message is indicative of the antenna modules being non-phase coherent.

17. The method according to claim 15, wherein the module arrangement message is indicative of the antenna modules having a same receive power in each given spatial direction.

18. The method according to claim 15, wherein the module arrangement message is comprised in a CED capability reporting message.

19. The method according to claim 15, wherein the module arrangement message comprises an indication indicative of a number of antenna modules comprised in the CED.

20. The method according to claim 15, wherein the module arrangement message is indicative of one or more of the plurality of antenna modules being co-oriented and offset.

21-30. (canceled)
